(19) United States
(12) Patent Application Publication
(10) Pub. No.: US 2023/0099217 A1
(43) Pub. Date: Mar. 30, 2023

(54) Method of connecting extruded chopped filament pipes

(71) Applicant: Exotex, Inc., Houston, TX (US)

(72) Inventors: Michael J. Parrella, Katy, TX (US); Nevil R. Ede, Westport, CT (US)

(21) Appl. No.: 17/488,821

(22) Filed: Sep. 29, 2021

(51) Int. Cl. F16L 55/175; F16L 55/168; F16L 55/165; B29C 48/00; B29C 48/151

(52) U.S. Cl. CPC F16L 55/175; F16L 55/1683; F16L 55/165; B29C 48/022; B29C 48/151; B29K 2101/12

(57) ABSTRACT

A method and apparatus for connecting pipe sections or repairing two separated pipe sections is provided, including for extruded chopped filament pipe (“ECFP”). An apparatus having a sealable connecting jacket is provided, which includes a mold configured to fit around a cut section of ECFP and receive a resin or other material through an input, and a curing system, such as a hot water intake surrounding the mold to heat and cure the resin forming the new pipe section.

### BACKGROUND OF THE INVENTION

The present application relates to a method of connecting pipe sections or repairing two separated pipe sections, including extruded chopped filament pipe (“ECFP”). The systems of the present application may be used with the pipes described in Applicant's International Patent Application Nos. PCT/US2016/052822 filed Sep. 21, 2016, and PCT/US2016/019068 and PCT/US2016/019077 filed Feb. 23, 2016, or Provisional Patent Application No. 62/832,589 filed Apr. 11, 2019, which are each incorporated by reference in their entireties.

### SUMMARY OF THE DISCLOSURE

The present application relates to a method of connecting pipe sections or repairing two separated pipe sections, including extruded chopped filament pipe (“ECFP”). A device having a sealable connecting jacket is provided, which includes a mold configured to fit around a cut section of pipe and receive a resin or other material through an input, and a curing system, such as a hot water intake surrounding the mold to heat and cure the resin forming the new pipe section.

In accordance with an aspect of the present application, a method for repairing a pipe is provided. The method comprises inserting a tube within two separated pipe segments to connect the two pipe segments; enclosing an exposed section of the tube between the two separated pipe segments in an apparatus comprising an outer jacket and a mold form within the outer jacket, the mold form having an inlet configured to receive a first material for reforming a pipe wall; injecting the first material into the inlet of the mold form to form a new segment of pipe wall connecting the two separated pipe segments; and removing the apparatus from the new segment of pipe wall.

In various embodiments of the method, the pipe repaired by the method can be an extruded chopped filament pipe comprising: an outer layer of a second material; and an inner layer of the first material in a hardened state, the first material comprising an extruded chopped filament and an epoxy resin. The extruded chopped filament can be glass or basalt fiber. The second material of the outer layer can be a thermoplastic material.

In further embodiments of the method, the method comprises, prior to enclosing the exposed section of the tube, removing a portion of the outer layer of each pipe segment adjacent to a gap between the two pipe segments to expose a portion of the inner layer of each pipe segment adjacent to the gap between the two pipe segments. The method may further comprise applying a thermally activated adhesive to outer surfaces of the exposed portion of the inner layer of each pipe segment.

In further additional or alternative embodiments of the method, the apparatus comprises two outer jacket sections configured to rotate about a hinge and the apparatus further comprises one or more bolts or clamps configured to seal the two outer jacket sections together. Injecting the first material into the inlet of the mold form may comprise injecting a mixture of the extruded chopped filament and the epoxy resin in a viscous state, and the mold form surrounds the exposed portion of the inner layer of each pipe segment and the tube within the two separated pipe segments to provide a new layer of the extruded chopped filament and the epoxy resin joining the two separated pipe segments.

In further additional or alternative embodiments of the method, the method may further comprise, prior to removing the apparatus, curing the new layer of the extruded chopped filament and the epoxy resin. The outer jacket of the apparatus may comprise a cavity surrounding the mold form and curing the new layer of the extruded chopped filament and the epoxy resin comprises injecting a heated liquid or gas into the cavity surrounding the mold form. The apparatus may further comprise a fluid circulation system comprising: a heater configured to receive a liquid or gas and heat the liquid or gas into the heated liquid or gas; a circulation line configured to provide the heated liquid or gas to a fluid inlet to the outer jacket cavity; and/or a fluid outlet of the outer jacket cavity configured to outlet cooled liquid or gas from the curing and provide the cooled liquid or gas to the heater.

In various further embodiments of the method, which may be in addition or alternative to the aforementioned embodiments, the method further comprises enclosing the new segment of pipe wall in a further outer layer of the second material. The method may also further comprise removing the tube from the new segment of pipe wall.

In accordance with a further aspect of the present application, an apparatus for use in a pipe repair process is provided. The apparatus comprises an outer jacket comprising two outer jacket sections connected by and configured to rotate about a hinge and enclose a cylindrical pipe segment to be repaired; one or more bolts or clamps configured to releasably seal the two outer jacket sections together around the pipe segment to be repaired; and a mold form arranged within the outer jacket comprising an inlet configured to receive a pipe repair material for reforming a segment of pipe wall. The outer jacket of the apparatus may further comprise a cavity arranged around the mold form configured to receive a curing liquid or gas configured to cure the pipe repair material. In further embodiments of the apparatus, the apparatus comprises a fluid circulation system comprising: a heater configured to receive a liquid or gas and heat the liquid or gas into the curing liquid or gas; and a circulation line configured to provide the curing liquid or gas to a fluid inlet to the outer jacket cavity. The fluid circulation system may further comprise a fluid outlet of the outer jacket cavity configured to outlet cooled liquid or gas from the curing and provide the cooled liquid or gas to the heater. The pipe repair material injected by the apparatus may include a combination of an extruded chopped filament and an epoxy resin.

### BRIEF DESCRIPTION OF THE FIGURES

FIG. 1 shows an example of a pipe that has been damaged with a gap formed between two pipe sections to be closed by connecting the two pipe sections;

FIG. 2 shows a first aspect of a pipe repair process according to the present application;

FIG. 3 shows a further aspect of the pipe repair process according to the present application;

FIG. 4A shows an open configuration of a connecting jacket used in the pipe repair process according to the present application;

FIG. 4B shows a closed configuration of a connecting jacket used in the pipe repair process according to the present application;

FIG. 5 shows a cross-sectional view of mold filled with an epoxy in accordance with an aspect of the pipe repair process according to the present application;

FIG. 6 shows a cross-sectional view of a mold curing phase in accordance with an aspect of the pipe repair process according to the present application;

FIG. 7 shows a pipe repaired in accordance with the pipe repair process of the present application.

### DETAILED DESCRIPTION OF THE FIGURES

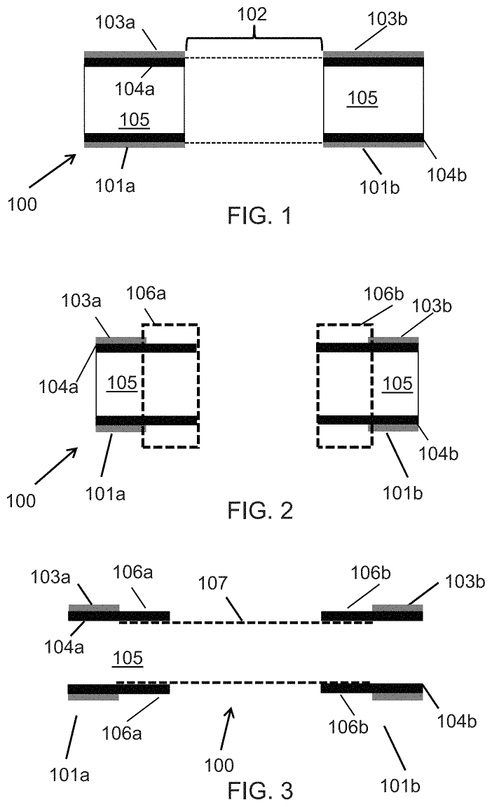

The present application will now be described with reference made to FIGS. 1-7.

In order to connect two existing sections of extruded chopped filament pipe (“ECFP”), or replace a damaged section of pipe 100, the present application provides a comprehensive system and method for repairing pipe.

FIG. 1 shows an example of a pipe 100 that has been damaged with a gap 102 formed between two pipe sections 101a, 101b that needs to be closed by connecting the two pipe sections 101a, 101b. The gap 102 can be the preexisting damage to the pipe 100 or can be made in an otherwise damaged section of pipe 100. The present application relates to an improved method for connecting such pipe sections 101a, 101b and repairing pipes 100.

The EFCP described herein and shown in the Figures include a hollow pipe interior 105 surrounded by an inner layer 104a, 104b including extruded chopped filament, such as glass or basalt fiber, and an epoxy resin, and an outer pipe layer 103a, 103b, such as a layer of a thermoplastic material such as polypropylene or PVC.

In a first part of the process, shown in FIG. 2, sections 106a, 106b of the outer pipe layers 103a, 103b adjacent to the gap 102 are cut away to expose the ends of each of the epoxy and filament formed pipe layers 104a, 104b. The outer pipe layers 103a, 103b can be cut using any cutting tool appropriate for the thermoplastic material or other material forming the outer pipe layers 103a, 103b. The exposed surface 106a, 106b of the epoxy and filament pipe is then cleaned and prepared, and a thermally activated adhesive is applied to the outer surface 106a, 106b of the cutaway epoxy and filament pipe, and allowed to dry.

Within the interior 105 of the pipe 100, a thin walled metal tube 107 is inserted, which has an outer diameter substantially equal to the diameter of the interior 105 of the pipe 100, an example of which is shown in FIG. 3. The metal tube or pipe 107 can be used to form the interior surface of the connection between the two pipe sections 101a, 101b, and the metal tube 107 may be removed after its use in the pipe repair system and process, or can be left in the pipe 100 after the pipe 100 has been repaired.

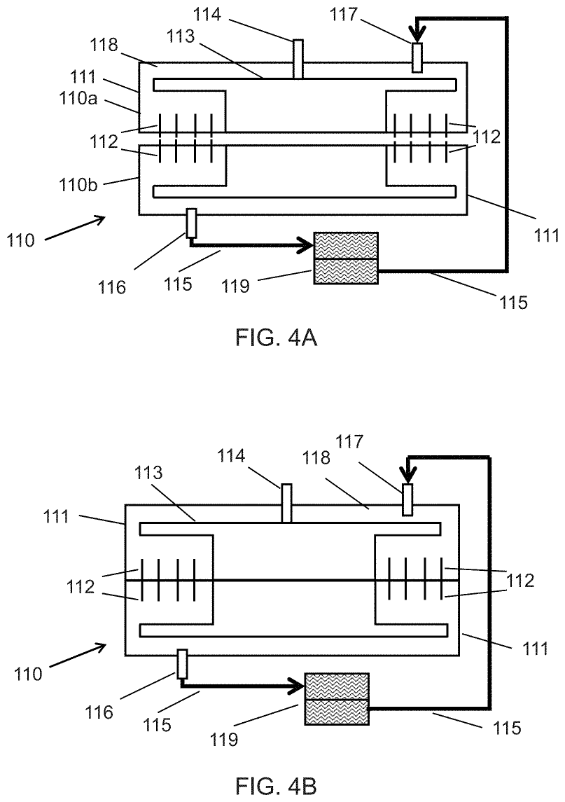

Once the pipe sections 101, 101b have been prepared, the pipe repair system of the present application provides for an apparatus or connecting jacket 110 to supply a new inner pipe segment 109 and a new outer pipe segment 108. A connecting jacket 110 is provided that allows for the application of extruded chopped filament and epoxy resin for forming a new layer 109, which is wrapped around metal tube 107 at the exposed section 106a, 106b of pipe 100, which is shown in FIGS. 4A-6.

The connecting jacket 110 features an outer jacket 111 having a jacket cavity 118 that can be flooded with hot water or steam to cure the new pipe layer 109, an inner liner 113 that forms the resin mold form 113 for the pipe, an inlet 114 to the resin mold 113 and an inlet 117 for hot water/steam. The connecting jacket 110 includes two sections 110a, 110b, each including a corresponding outer jacket 111 and resin mold form or inner liner 113, and bolts or clamps 112 are provided so that the two sections 110a, 110b can be bolted or clamped together and sealed in a “clam shell manner.” A seal between the mold form 113 and the cut section 106a, 106b of the pipe 100 is achieved through the temporary adhesive that was applied to the outer surface 106a, 106b of the cutaway epoxy and filament pipe. FIG. 4A shows an example of the connecting jacket 110 in an open configuration, and FIG. 4B shows an example of the connecting jacket 110 in a closed configuration, with the two sections 110a, 110b clamped and sealed.

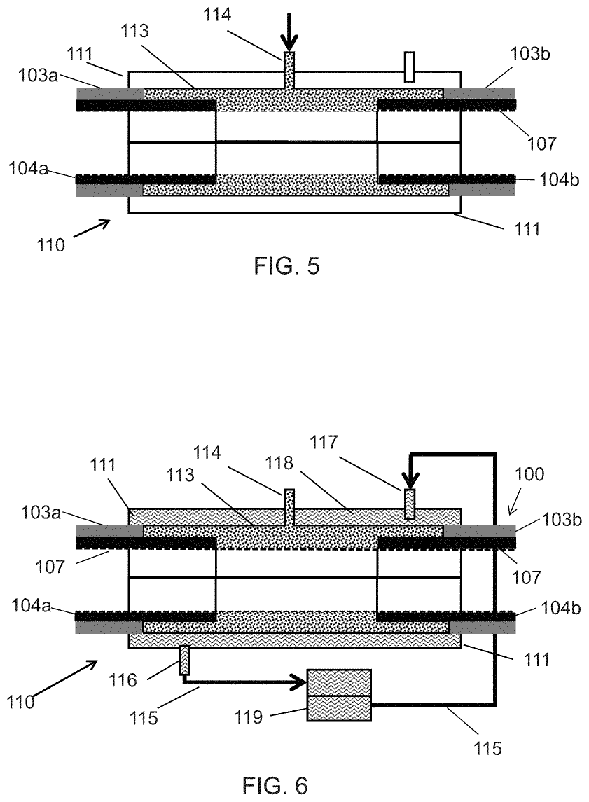

The mold form 113 can then be filled with the epoxy resin including the extruded chopped fiber filament, as shown in FIG. 5. An inlet 114 is provided, which is connected to a supply of the epoxy resin (not shown) that feeds the epoxy resin into the mold form 113. The epoxy resin can be the same material used for the inner layers 104a, 104b, or may be a suitable substitute material. The resin mold 113 fits around the inner tube 107 and is filled with the resin around the tube 107, without entering the interior 105 of the pipe 100.

A curing process is then applied to cure the layer 109 of the inserted material, for example by filling the cavity 118 of the connecting jacket 110 with hot water or steam as determined by epoxy system curing protocol, as shown in FIG. 6. A water circulation system 115 is provided between a water outlet 116 and a water inlet 117, with a heater 119 positioned in between, which reheats water that is drained from the water outlet 116 of the connecting jacket 110, and supplies it back to the hot water or steam inlet 117.

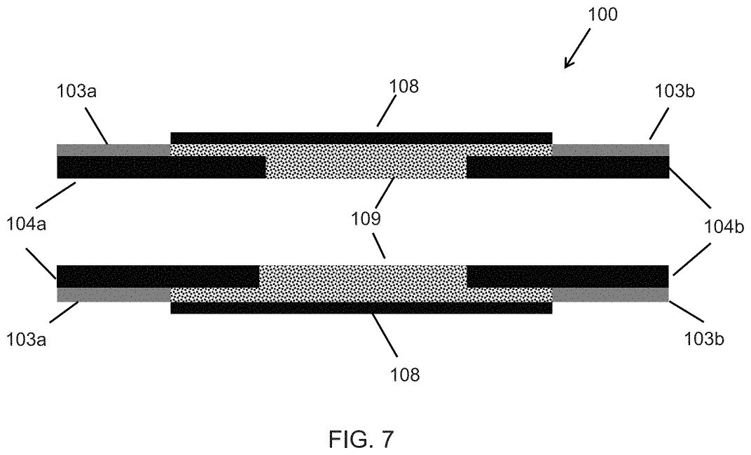

Once the molded section 109 has been cured, the connecting jacket 110 is removed. The tube 107 inside the pipe 100 may also be removed as required. An outer covering 108 of thermoplastic material may be applied to the new layer 109 of molded epoxy and chopped fiber section for protection as required to provide a new outer section 108 of the pipe 100, as shown in FIG. 7.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale. Although the invention has been described and illustrated with respect to exemplary embodiments thereof, the foregoing and various other additions and omissions may be made therein and thereto without departing from the spirit and scope of the present invention.

What is claimed:

1. A method for repairing a pipe, comprising:
inserting a tube within two separated pipe segments to connect the two separated pipe segments;
enclosing an exposed section of the tube between the two separated pipe segments in an apparatus comprising an outer jacket and a mold form within the outer jacket, the mold form having an inlet configured to receive a first material for reforming a pipe wall;
injecting the first material into the inlet of the mold form to form a new segment of pipe wall connecting the two separated pipe segments; and
removing the apparatus from the new segment of pipe wall.

2. The method according to claim 1, wherein the pipe is an extruded chopped filament pipe, the pipe and the separated pipe segments comprising:
an outer layer of a second material; and
an inner layer of the first material in a hardened state, the first material comprising an extruded chopped filament and an epoxy resin.

3. The method according to claim 2, wherein the extruded chopped filament is glass or basalt fiber.

4. The method according to claim 2, wherein the second material of the outer layer is a thermoplastic material.

5. The method according to claim 2, further comprising, prior to enclosing the exposed section of the tube, removing a portion of the outer layer of each pipe segment adjacent to a gap between the two separated pipe segments to expose a portion of the inner layer of each pipe segment adjacent to the gap between the two separated pipe segments.

6. The method according to claim 5, further comprising applying a thermally activated adhesive to outer surfaces of the exposed portion of the inner layer of each pipe segment.

7. The method according to claim 5, wherein the apparatus comprises two outer jacket sections configured to rotate about a hinge and the apparatus further comprises one or more bolts or clamps configured to seal the two outer jacket sections together.

8. The method according to claim 7, wherein injecting the first material into the inlet of the mold form comprises injecting a mixture of the extruded chopped filament and the epoxy resin in a viscous state, and wherein the mold form surrounds the exposed portion of the inner layer of each pipe segment and the tube within the two separated pipe segments to provide a new layer of the extruded chopped filament and the epoxy resin joining the two separated pipe segments.

9. The method according to claim 8, further comprising:
prior to removing the apparatus, curing the new layer of the extruded chopped filament and the epoxy resin.

10. The method according to claim 9, wherein the outer jacket of the apparatus comprises a cavity surrounding the mold form, and curing the new layer of the extruded chopped filament and the epoxy resin comprises injecting a heated liquid or gas into the cavity surrounding the mold form.

11. The method according to claim 10, wherein the apparatus comprises a fluid circulation system comprising:
a heater configured to receive a liquid or gas and heat the liquid or gas into the heated liquid or gas; and
a circulation line configured to provide the heated liquid or gas to a fluid inlet to the cavity of the outer jacket.

12. The method according to claim 11, wherein the fluid circulation system further comprises:
a fluid outlet of the outer jacket cavity configured to outlet cooled liquid or gas from the curing and provide the cooled liquid or gas to the heater.

13. The method according to claim 2, further comprising enclosing the new segment of pipe wall in a further outer layer of the second material.

14. The method according to claim 1, further comprising removing the tube from the new segment of pipe wall.

15. An apparatus for use in a pipe repair process, comprising:
an outer jacket comprising two outer jacket sections connected by and configured to rotate about a hinge and enclose a cylindrical pipe segment to be repaired;
one or more bolts or clamps configured to releasably seal the two outer jacket sections together around the pipe segment to be repaired; and
a mold form arranged within the outer jacket comprising an inlet configured to receive a pipe repair material for reforming a segment of pipe wall.

16. The apparatus according to claim 15, wherein the outer jacket further comprises a cavity arranged around the mold form configured to receive a curing liquid or gas configured to cure the pipe repair material.

17. The apparatus according to claim 16, further comprising:
a fluid circulation system comprising:
a heater configured to receive a liquid or gas and heat the liquid or gas into the curing liquid or gas; and
a circulation line configured to provide the curing liquid or gas to a fluid inlet to the outer jacket cavity.

18. The apparatus according to claim 17, wherein the fluid circulation system further comprises a fluid outlet of the outer jacket cavity configured to outlet cooled liquid or gas from the curing and provide the cooled liquid or gas to the heater.

19. The apparatus according to claim 15, wherein the pipe repair material comprises an extruded chopped filament and an epoxy resin.
